(19) United States
(12) Patent Application Publication
(10) Pub. No.: US 2017/0077553 A1
(43) Pub. Date: Mar. 16, 2017

(54) NON-AQUEOUS ELECTROLYTE SECONDARY BATTERY

(71) Applicant: Sanyo Electric Co., Ltd., Daito-shi, Osaka (JP)

(72) Inventors: Tatsuki Hiraoka, Hyogo (JP); Masahiro Shiraga, Osaka (JP)

(73) Assignee: Sanyo Electric Co., Ltd., Daito-shi, Osaka (JP)

(21) Appl. No.: 15/125,269

(22) PCT Filed: Mar. 11, 2015
(86) PCT No.: PCT/JP2015/001321

§ 371 Date: Sep. 12, 2016

(30) Foreign Application Priority Data
Mar. 14, 2014 (JP) 2014-051532

(51) Int. Cl. H01M 10/0569; H01M 10/0567; H01M 4/48; H01M 4/587; H01M 4/525; H01M 4/36

(52) U.S. Cl. CPC H01M 10/0569; H01M 4/525; H01M 4/366; H01M 4/483; H01M 4/587; H01M 10/0567; H01M 2300/004

(57) ABSTRACT

The nonaqueous electrolyte secondary battery includes a positive electrode, a negative electrode, and a nonaqueous electrolytic solution and is characterized in that the nonaqueous electrolytic solution contains propylene carbonate and fluoroethylene carbonate, the positive electrode contains an oxide that contains lithium and one or more metallic elements M as a positive electrode active material, the one or more metallic elements M include at least one selected from the group consisting of cobalt and nickel, the negative electrode contains graphite as an active material, the negative electrode active material includes lithium and a lithium carbonate layer with a thickness of 1 μm or less on the surface thereof, and the ratio of the total lithium content a of the positive and negative electrodes to the metallic element M content Mm of the oxide, a/Mm, is greater than 1.01.

### TECHNICAL FIELD

The present invention relates to nonaqueous electrolyte secondary batteries and particularly relates to a nonaqueous electrolyte secondary battery with superior high-temperature characteristics.

### BACKGROUND ART

Conventional nonaqueous electrolyte secondary batteries commonly use graphitic negative electrode. active materials. More recently, researchers have been investigating the use of mixtures of high-capacity negative electrode materials, including metals that can be alloyed with lithium such as silicon, germanium, tin, and zinc and oxides of these metals, with graphitic materials aimed at improving the energy density and output.

When a graphitic material is used, however, the negative electrode active material changes its volume when storing lithium. Such volume changes break the coating on the surface of the material, and the formation of a new coating to compensate for the lost coating consumes lithium ions. Graphitic materials therefore have the disadvantages of low charge and discharge capacities and a short battery an the other hand, high-capacity negative electrode materials have the disadvantage of low battery energy density because of their large irreversible capacities in the first cycle of charging and discharge.

In response to these problems, PTL 1 discloses a method in which a negative electrode is pre-lithiated to prevent lithium ions from being completely desorbed from the negative electrode in the late stage of discharge and thereby to avoid sudden changes in the volume of a negative electrode active material. Furthermore, PTL 2 discloses a nonaqueous electrolyte secondary battery that has been pre-lithiated to an extent corresponding to the irreversible capacity of a high-capacity negative electrode material.

### CITATION LIST

### Patent Literature

PTL 1: Japanese Published Unexamined Patent Application No. 2005-294028

PTL 2: Japanese Published Unexamined Patent Application No. 2007-242590

### SUMMARY OF INVENTION

### Technical Problem

However, we have found that the nonaqueous electrolyte secondary batteries disclosed in PTL 1 and 2 are disadvantageous in that they produce oxidation gases when stored at high temperatures, although improved in terms of efficiency in the first cycle of charging and discharging and cycle characteristics.

This can be described more specifically as follows. A typical way to reduce the production of oxidation gases is the use of propylene carbonate (PC), which is highly resistant to oxidation, as a solvent When the PC solvent is used with a graphitic material, however, no SEI (Solid Electrolyte Interphace) is formed, and the delamination of graphite progresses.

The use of PC as a solvent leads to lithium ions not being released from solvent (desolvated). The PC solvent is intercalated into the graphite while solvating lithium ions (co-intercalated), increasing the interlayer spacing of the graphite and delaminating the graphite.

For this reason, batteries with graphitic materials often suffer from the production of oxidation gases during storage at high temperatures because the PC solvent cannot be used.

### Solution to Problem

To solve this problem, the nonaqueous electrolyte secondary battery according to the present invention, which includes a positive electrode, a negative electrode, and a nonaqueous electrolytic solution, is characterized in that the nonaqueous electrolytic solution contains propylene carbonate (PC) and fluoroethylene carbonate (FEC), the positive electrode contains an oxide that contains lithium and one or more metallic elements M as a positive electrode active material, the one or more metallic elements N include at least one selected from the group consisting of cobalt and nickel, the negative electrode contains graphite as a negative electrode active material, the negative electrode active material includes lithium and a lithium carbonate layer with a thickness of 1 μmm or less on the surface thereof, and the ratio of the total lithium content a of the positive and negative electrodes to the metallic element N content Mm of the oxide, a/Mm, is greater than 1.01.

According to the present invention, the electrolytic solution contains FEC, and the negative electrode has been pre-lithiated. This ensures that the potential near the negative electrode is 1 V (vs. Li) or less immediately after immersion. The FEC near the negative electrode is therefore exposed to a potential lower than its reductive decomposition potential, 1.4 V. As a result, the reductive decomposition of the FEC progresses on the surface of the negative electrode active material, and a coating is formed on the surface of the negative electrode active material without needing charging.

The supplementary lithium, which has been intercalated into the graphite as a negative electrode active material, is not solvated by the PC, and the graphite does not delaminate immediately after immersion. The battery can be charged with controlled delamination of the graphite thereafter, even with the PC solvent, in the electrolytic solution, because the coating formed by the FEC in advance promotes the desolvation of lithium ions from the PC.

If no FEC is used in the electrolytic solution, no coating is formed on the surface of the graphite in advance, and therefore the desolvation of lithium from the PC solvent is not promoted.

If a negative electrode that has not been pre-lithiated is used, the potential near the negative electrode is approximately 3.2 V immediately after immersion. This not as low as the reduction potential for FEC, and this no coating is formed on the surface of the negative electrode active material. When the battery is charged using graphite as a negative electrode active material and the PC solvent, therefore, the PC can solvate lithium ions simultaneously with the reductive decomposition of the FEC. This solvation causes the PC solvent to be co-intercalated into regions where no FEC coating has been formed. The delamination of graphite progresses accordingly, and the battery capacity is reduced.

### Advantageous Effects of Invention

The nonaqueous electrolyte secondary battery according to the present invention improves high-temperature storage characteristics by limiting the production of oxidation gases during storage at high temperatures.

### DESCRIPTION OF EMBODIMENTS

The following describes an embodiment Of the present invention in detail.

A nonaqueous electrolyte secondary battery as an example of an embodiment of the present invention includes A positive electrode that contains a positive electrode active material, a negative electrode that contains a negative electrode active material, a nonaqueous electrolyte that contains a nonaqueous solvent, and a separator. An example of a nonaqueous electrolyte secondary battery is a structure in which an electrode body composed of positive and negative electrodes wound with a separator therebetween and a nonaqueous electrolyte are held together in a sheathing body.

The positive electrode is preferably composed of a positive electrode collector and a positive electrode active material layer on the positive electrode collector. The positive electrode collector is, for example, a conductive thin-film body, in particular a foil of a metal or alloy that is stable in the range of positive electrode potentials, such as aluminum, or a film that has a surface layer of a metal such as aluminum. The positive electrode active material layer contains a positive electrode active material, preferably with a conductive material and a binder.

The positive electrode active material contains an oxide that contains lithium and one or more metallic elements M, and the one or more metallic elements M include at least one selected from the group consisting of cobalt and nickel. Preferably, the oxide is a lithium transition metal oxide. The lithium transition metal oxide may contain non-transition metals, such as Mg and Al. Specific examples include lithium transition metal oxides such as lithium cobalt oxide, Ni—Co—Mn, Ni—Mn—Al, and Ni—Co—Al. The positive electrode active material can be one of these, and can also be a mixture of two or more.

The negative electrode preferably includes a negative electrode collector and a negative electrode active material layer on the negative electrode collector. The negative electrode collector is, for example, a conductive thin-film body, in particular a foil of a metal or alloy that is stable in the range of negative electrode potential such as copper, or a film that has a surface layer of a metal such as copper. The negative electrode active material layer contains a negative electrode active material, preferably with a binder. The binder can be a material such polytetrafluoroethylene, but preferably is a material such as styrene-butadiene rubber (SBR) or polyimide. The binder may be used in combination with a thickener such as carboxymethyl cellulose.

The negative electrode is preferably a graphitic material or a mixture of a graphitic material and SiOₓ (x=0.5 to 1.5).

The preferably has a Conductive. Coating layer with which at last part of its surface is covered. The coating layer is a conductive layer formed from a material that has higher conductivity than the SiOₓ. The coating layer is preferably made of an electrochemically stable conductive material, preferably at least one selected from the group consisting of carbon materials, metals, and metallic compounds.

The ratio by mass of SiOₓ to graphite is preferably from 1:99 to 50:50, more preferably from 10:90 to 20:80. When the proportion of SiOₓ to the total mass of the negative. electrode active material is less than 1% by mass, the increased capacity provided by the SiOₓ is only a small advantage.

The nonaqueous electrolyte secondary battery according to the present invention has been pre-lithiated to an extent corresponding to the irreversible capacity of the negative electrode. A preferred method for pre-lithiating the battery to an extent corresponding to the irreversible capacity is to pre-lithiate the negative electrode to an extent corresponding to its irreversible capacity. Examples of methods for pre-lithiating the negative electrode to an extent corresponding to its irreversible capacity include electrochemical charging with lithium, attaching metallic lithium to the negative electrode, depositing lithium on the surface of the negative electrode, and pre-doping the negative electrode active material with a lithium compound.

When the positive electrode active material contains an oxide that contains lithium and one or more metallic elements M with the one or more metallic elements M including at least one selected from a group including cobalt and nickel, it is preferred that the ratio of the total lithium content a of the positive and negative electrodes to the metallic element M content Mm of the oxide, a/Mm, be greater than 1.01, more preferably greater than 1.03. When the ratio a/Mm falls within these ranges, the proportion of lithium ions supplied inside the battery is very large. Such a ratio is therefore advantageous to the compensation for the irreversible capacity.

This ratio a/Mm varies with, for example, the amount of metallic lithium foil attached to the negative electrode. The ratio a/Mm can be determined by assaying the positive and negative electrodes and the positive electrode active material for lithium content a and metallic element M content Mm, respectively, and dividing the amount a by the metallic element N content Mm.

The assays for the lithium content a and the metallic element M Content Mm can be made as follows.

First, the battery is fully discharged and then disassembled. The nonaqueous electrolyte is removed, and the inside of the battery is washed using solvent such as dimethyl carbonate. Samples of the positive and negative electrodes in predetermined masses are then assayed by ICP analysis for the lithium content levels of the positive, and negative electrodes to determine the molar lithium content a. In the same way as the lithium content of the positive electrode, the metallic element M content Mm of the positive electrode is measured by ICP analysis.

Alternatively, the ratio a/Mm can be determined by calculating the amount of supplementary lithium to match the designed near-negative electrode potential for the period immediately after immersion.

The negative electrode that has been pre-lithiated in this way includes a lithium carbonate layer with a thickness of 1 μm or less on the surface of the active material.

The electrolytic salt for the nonaqueous electrolyte can be, for example LiClO₄, LiBF₄, LiPF₆, LiAlCl₄, LiSbF₆, LiSCN, LiCF₃SO₃, LiCF₃CO₂, LiAsF₆, LiB₁₀Cl₁₀, a lower aliphatic carboxylic acid lithium salt, LiCl, LiBr, LiI, chloroborane lithium, a boric acid salt, or an imide salt. LiPF₆ is particularly preferred because of its ionic conductivity and electrochemical stability. Electrolytic salts can be used alone, and a combination of two or more electrolytic salts can also be used. These electrolytic salts are preferably contained in a proportion of 0.8 to 1.5 mol per L of the nonaqueous electrolyte.

The solvent for the nonaqueous electrolyte contains propylene carbonate (PC) and fluoroethylene carbonate (FEC). It is preferred that the PC constitute 5% or more and 25% or less as a ratio by volume in the solvent, and it is preferred that the FEC solvent constitute 1% or more and 5% or less as a ratio by mass in the solvent.

Other solvents that can be used are cyclic carbonates, linear carbonates, and cyclic carboxylates.

Examples of cyclic carbonates include ethylene carbonate (EC) as well as PC and FEC.

Examples of linear carbonates include diethyl carbonate (DEC), ethyl methyl carbonate (EMC), and dimethyl carbonate (DMC).

Examples of cyclic carboxylates include γ-butyrolactone (GBL) and γ-valerolactone (GVL). Examples of linear carboxylates include methyl propionate (MP) fluoromethyl propionate (FMP).

The separator is an ion-permeable and insulating porous sheet. Specific examples of porous sheets include microporous thin film, woven fabric, and nonwoven fabric. The separator is preferably made of a polyolefin, such as polyethylene or polypropylene.

### EXAMPLES

The following describes the present invention in more detail by providing some examples. However, the present invention is not limited to these examples.

### Experimental Example 1

### (Preparation of Positive Electrode)

Lithium cobalt oxide, acetylene black (HS100, Denki Kagaku Kooyo K.K), and polyvinylidene fluoride (PVdF) were weighed out and mixed to a ratio by mass of 95.0:2.5:2.5, and N-methyl-2-pyrrolidone (NMP) as a dispersion medium was added.

Positive electrode slurry was prepared by stirring the mixture using a mixer (T.K. HIVIS MIX, PRIMIX Corporation). This positive electrode slurry was applied to both sides of an aluminum foil as a positive electrode collector, followed by drying and rolling with a roller. In this way, positive electrode was prepared as a positive electrode collector with a positive electrode mixture layer on each side thereof. The packing density in the positive electrode mixture layer was 3.60 g/ml.

### (Preparation of Negative Electrode)

A mixture of carbon-coated SiOₓ (x=0.93; average primary particle diameter, 6.0 μm) and graphite (average primary particle diameter: 10 μm) in a 10:90 ratio b mass was used as the negative electrode active material. This negative electrode active material, carboxymethyl cellulose (CMC) as a thickener, and SER (styrene-butadiene rubber) as a binder were mixed to a ratio by mass of 98:1:1, and water as a diluent was added. Negative electrode slurry was prepared by stirring the mixture using a mixer (T.K. HIVIS MIX, PRIMIX Corporation)

This negative electrode slurry was uniformly applied to both sides of a copper foil as a negative electrode collector, with the mass of the resulting negative electrode mixture layer per m² being 190 g. These coatings were dried in air at 105° C. and rolled using a roller. In this way, negative electrode was prepared as a negative electrode collector with a negative electrode mixture layer on each side thereof. The packing density in the negative electrode mixture layer was 1.60 q/ml.

### (Lithiation)

As lithium for pre-lithiation, a metallic lithium layer with a thickness of 5 μm (corresponding to the irreversible capacity of the negative electrode) was formed on a copper foil using vacuum deposition under the following deposition conditions. The evaporation source was a tantalum evaporation boat (Furuuchi Chemical), and a metallic lithium rod (Honjo Chemical) was placed in the evaporation boat. With this evaporation boat connected to a direct-current power supply placed outside the vacuum chamber, the metallic lithium rod was evaporated by resistance heating to form a metallic lithium layer on a copper foil by vacuum deposition.

The copper foil with the metallic lithium layer thereon and the negative electrode were put on top of each other and combined together with a roller therebetween in a dry air atmosphere, and the copper foil alone was removed. In this way, the negative electrode was lithiated.

### (Preparation of Nonaqueous Electrolytic Solution)

A nonaqueous electrolytic solution was prepared by adding, to a solvent mixture composed of ethylene carbonate (EC), propylene carbonate (PC), and diethyl carbonate (DEC) mixed in a 2.5:0.5:7 ratio volume, 2% by mass fluoroethylene carbonate (FEC) and then 1.0 mole/liter of lithium hexafluorophosphate (LiPF₆)

### (Assembly of Battery)

A wound electrode body was prepared in a dry it atmosphere by attaching a tab to each of the electrodes and winding the positive and negative electrodes into a spiral with the separator therebetween and the tabs at the outermost periphery. This electrode body was inserted into a sheathing body composed of laminated aluminum sheets. After 2 hours of drying in a vacuum at 105° C., the nonaqueous electrolytic solution was injected, and the opening of the sheathing body was sealed. In this way, battery 1 was assembled.

The thickness of the lithium carbonate layer in battery 1 as measured by X-ray photoelectron spectroscopy surface analysis (depth profiling) was 0.3 μm.

The ratio a/Mm of the total lithium content a to the metallic element M (Co) content Mm was 1.08. The design capacity of battery 1 was 800 mAh.

### Experimental Example 2

Battery 2 was produced in the same way as battery 1 except that in the conditioning of the nonaqueous electrolytic solution, the ratio by volume of EC to PC to DEC was 1.5:1.5:7.

### Experimental Example 3

Battery 3 was produced in the same way as battery 1 except that in the conditioning of the nonaqueous electrolytic solution, the ratio by volume EC to PC to DEC was 05:25:7.

### Experimental Example 4

Battery 4 was produced in the same way as battery 2 except that in the conditioning of the nonaqueous electrolytic solution, the amount of FEC added was 5%.

### Experimental Example 5

Battery 5 was produced in the same way as battery 1 except that in the conditioning of the nonaqueous electrolytic solution, the ratio by volume of EC to PC to DEC was 0:3:7.

### Experimental Example 6

Battery 6 was produced in the same way as battery 1 except that in the conditioning of the nonaqueous electrolytic solution, the ratio by volume of EC to PC to DEC was 3:0:7.

### (Experimental Example 7

Battery 7 was produced in the same way as battery 2 except that in the conditioning of the nonaqueous electrolytic solution, the amount of FEC added was 1%.

### (Experimental Example 8

Battery 8 was produced in the same way as battery 2 except that in the conditioning of the nonaqueous electrolytic solution, no FEC was added.

### Experimental Example 9

Battery 9 was produced in the same way as battery 6 except that lithiation was omitted.

### Experimental Example 10

Battery 10 was produced in the as battery 9 except that in the conditioning of the nonaqueous electrolytic solution, the ratio by volume of EC to PC to DEC was 1.5:1.5:7.

### Experimental Example 11

Battery 11 was produced in the same way as battery 2 except that the steps of lithiating the negative electrode and preparing the wound electrode body were performed in air and that the thickness of the lithium carbonate layer was 1.1 μm.

Batteries 1 to 11 were charged and discharged under the conditions below, and their initial efficiency (efficiency in the first cycle of charging and discharge) was determined according to formula (1).

### Charge and Discharge Conditions

Constant-current charging was performed at a 1.0-It (800-mA) current until the battery voltage reached 4.2 V. Constant-voltage charging was then performed at a voltage of 4.2 V until the current reading reached 0.05 It (40 mA). After a halt of 10 minutes, constant-current discharge was performed at a 1.0-It (800-mA) current until the battery voltage reached 2.75 V.

### (Calculation of Initial Efficiency)

Initial efficiency=(Discharge efficiency capacity at cycle 1/Charge capacity at cycle 1)×100 (1)

The results of the determination of initial efficiency by battery are summarized in Table 1.

### (Measurement of the Amount of was After Storage)

The batteries that completed the first cycle of charging and discharge were then subjected to a constant current charging at a 1.0-It (800-mA) current to a battery voltage of 4.2 V, a constant-voltage charging at a voltage of 4.2 V to a current reading of 0.05 It (40 mA), and 2 days of storage at 80° C. The stored batteries were examined for gas production. The results are summarized in Table 1.

The gas production was measured by a buoyancy method. More specifically, the difference between the mass of a stored battery in water and that of the battery in water measured before storage was defined as the production of gas during storage. The main component of the generated gas was oxidation gases including CO₂ and CO gases.

TABLE 1

| | | | | | | Initial | Amount of |
|---|---|---|---|---|---|---|---|
| Battery | EC | PC | DEC | FEC | Lithiated | efficiency | storage as |
| 1 | 2.5 | 0.5 | 7 | 2% | Yes | 90% | 1.5 cc |
| 2 | 1.5 | 1.5 | 7 | 2% | Yes | 90% | 1.3 cc |
| 3 | 0.5 | 2.5 | 7 | 2% | Yes | 90% | 1.0 cc |
| 4 | 1.5 | 1.5 | 7 | 5% | Yes | 91% | 1.6 cc |
| 5 | 0 | 3 | 7 | 2% | Yes | 90% | 1.5 cc |
| 6 | 3 | 0 | 7 | 2% | Yes | 90% | 1.7 cc |
| 7 | 1.5 | 1.5 | 7 | 1% | Yes | 90% | 1.2 cc |
| 8 | 1.5 | 1.5 | 7 | 0% | Yes | 86% | 1.6 cc |
| 9 | 3 | 0 | 7 | 2% | No | 82% | 1.7 cc |
| 10 | 1.5 | 1.5 | 7 | 2% | No | 76% | 2.3 cc |
| 11 | 1.5 | 1.5 | 7 | 2% | Yes | 88% | 1.8 cc |

It was found that batteries 1 to 3, in which PC was used in the electrolytic solution, displayed decreases in the amount of storage: gas compared with battery 6, in which no PC was used in the electrolytic solution, while preserving an initial efficiency of 90%. Furthermore, the amount of storage gas was more effectively reduced with increasing amount of PC introduced. This is because carbon dioxide forming through the oxidation of EC was decreased accordingly with the increase in the proportion of PC.

However, further increasing the proportion of PC. leads to less effective control of storage characteristics as demonstrated by battery . This is presumably because the delamination of graphite is beginning to progress at regions where the coating on the surface of the negative electrode active material is thin. Thus, it is more preferred that the proportion by volume or PC to the solvent for the nonaqueous electrolyte be 5% or more and 25% or less.

Increasing the amount of FEC, as demonstrated by battery 4, led to a large amount of storage gas compared with that of battery 2. This seems to be because the oxide gas produced by the auto-decomposition of FEC has some effect when the amount of FEC increases. Thus, it is more preferred that the proportion by mass of FEC to the solvent for the nonaqueous electrolytic solution be 1% or more and 5% or less. This battery performed well in terms of initial efficiency, indicating that the amount of FEC has no effect on the formation of the coating on the surface of the negative electrode active material.

Battery 8, in which no FEC was added, displayed a low initial efficiency compared with battery 2. This seems to be because no coating of FEC was formed on the surface of the negative electrode, and as a result the desolvation of lithium ions from PC was not promoted, allowing the delamination of graphite to progress.

For battery 9, which was not lithiated, the initial efficiency was reduced as a result of the irreversible capacity of the negative electrode. Similar to the case of battery 5, the amount of storage gas was large because no PC was used.

Battery 10 exhibited a considerably reduced initial efficiency. This is considered to be because reductive decomposition of FEC accompanied by the solvation of lithium ions by PC allowed the delamination of graphite to progress.

For battery 11, the initial efficiency was and no gas-controlling effect. was observed. The decrease in initial efficiency seems to be because of the failure to save the amount of lithium corresponding to the irreversible capacity by virtue of all of the lithium with which the negative electrode was pre-doped reacting with atmospheric water or carbon dioxide. The lack of the gas-controlling effect is presumably because the advantages of the present invention were lost due to lithium deactivation and because a gas derived from the generated lithium carbonate increased.

1. A nonaqueous electrolyte secondary battery comprising a positive electrode, a negative electrode, and a nonaqueous electrolytic solution, wherein:
the nonaqueous electrolytic solution contains propylene carbonate and fluoroethylene carbonate;
the positive electrode contains an oxide that contains lithium and one or more metallic elements M as a positive electrode active material;
the one or more metallic elements M include at least one selected from the group consisting of cobalt and nickel;
the negative electrode contains graphite as a negative electrode active material;
the negative electrode active material includes lithium and a lithium carbonate layer with a thickness of 1 μm or less on a surface thereof; and
a ratio of a total lithium content a of the positive and negative electrodes to a metallic element M content Mm of the oxide a/Mm, is greater than 1.01.

2. The aqueous electrolyte secondary battery according to claim 1, wherein the negative electrode active material contains SiOₓ (x=0.5 to 1.5).

3. The nonaqueous electrolyte secondary battery according to claim 1, wherein a proportion by volume of the propylene carbonate to solvent for the nonaqueous electrolytic solution is 5% or more and 25% or less.

4. The nonaqueous electrolyte secondary battery according to claim 1, wherein a proportion by mass of the fluoroethylene carbonate to solvent for the nonaqueous electrolytic solution is 1% or more and 5% or less.
